(19) United States
(12) Patent Application Publication
(10) Pub. No.: US 2003/0198489 A1
(43) Pub. Date: Oct. 23, 2003

(54) A FOOLPROOF DEVICE USED IN A PROCESS CARTRIDGE OF AN IMAGE FORMING APPARATUS

(76) Inventors: Ren-Hao Liu, Taichung City (TW); Shu Hui Wang, Taichung (TW); Xiao Hui Wang, Taichung (TW); Ting Hsuan Ko, Taichung (TW); Jui-Chi Wang, Taichung (TW); Robin Hsu, Taichung City (TW); Ya Li Huang, Taichung (TW); Kuan Tung Li, Yunlin (TW); Hui Wen Hsieh, Feng-Yuan City (TW)

Correspondence Address: MERCHANT & GOULD PC, P.O. BOX 2903, MINNEAPOLIS, MN, 55402-0903, US

(21) Appl. No.: 10/171,036

(22) Filed: Jun. 11, 2002

(30) Foreign Application Priority Data
Feb. 8, 2002 (TW) 091201949

(51) Int. Cl. G03G 15/08

(52) U.S. Cl. 399/262

(57) ABSTRACT

A foolproof device used in a process cartridge of an image forming apparatus formed of a developing device and a toner container is constructed to include female engagement portions of two different sizes formed in the toner container, and male engagement portions of two different sizes formed in the developing device and adapted for guiding correct installation of the toner container in the developing device and securing the toner container to the developing device positively.

### BACKGROUND OF THE INVENTION

1. Field of the Invention

The present invention relates to a process cartridge for image forming apparatus and, more specifically, to a foolproof device used in an image forming apparatus, which prevents an installation error of the toner container in the developing device.

2. Description of the Related Art

A regular process cartridge for a laser printer is generally comprised of an electrophotographic photosensitive member, developing means, charging means, cleaning means, and a toner container. When the toner of the toner container used up, the whole assembly of the process cartridge becomes useless and must be thrown away. It is not economic to throw the whole assembly of the process cartridge away after empty of the process cartridge. Further, the waste process cartridge may cause pollution to the environment if it is not well disposed of.

### SUMMARY OF THE INVENTION

The present invention has been accomplished to eliminate the aforesaid drawbacks. It is the main object of the present invention to provide a process cartridge, which enables the user to replace the toner container without throwing the other parts of the process cartridge away when toner used up. It is another object of the present invention to provide a foolproof device, which prevents leakage of toner due to an installation error of the toner container in the developing device. To achieve these and other objects of the present invention, the foolproof device comprises a plurality of male engagement portions and a plurality of female engagement portions respectively formed in the developing device and toner container of the process cartridge of an image forming apparatus. The male engagement portions are different in size. The female engagement portions are different in size and, fit the male engagement portions respectively. The foolproof device guides correct installation of the toner container in the developing device, preventing leakage of toner due to a wrong installation of the toner container in the developing device.

### BRIEF DESCRIPTION OF THE DRAWINGS

FIG. 1 is an exploded view of the preferred embodiment of the present invention.

FIG. 2 is a front elevational view of the toner container according to the present invention.

FIG. 3 illustrates the female engagement portions of the toner container respectively attached to the female engagement portions of the developing device and set in the initial engagement position.

FIG. 4 illustrates the toner container installed in the developing device according to the present invention.

### DETAILED DESCRIPTION OF THE PREFERRED EMBODIMENT

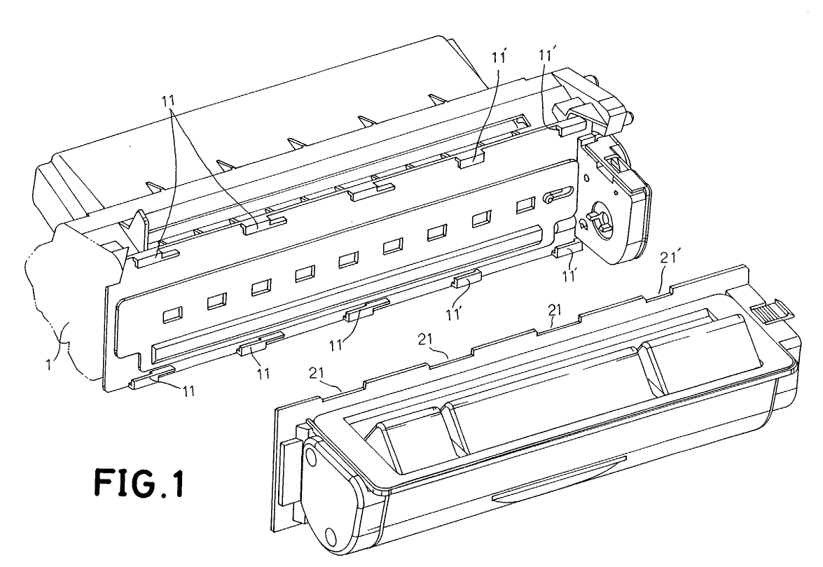

Referring to FIG. 1, a process cartridge constructed in accordance with the present invention is shown comprised of a developing device 1 and a toner container 2.

The developing device 1 comprises electrophotographic photosensitive means, developing means, process device matching the developing means (these attached means are not within the scope of the claims of the present invention, no further detailed description is necessary).

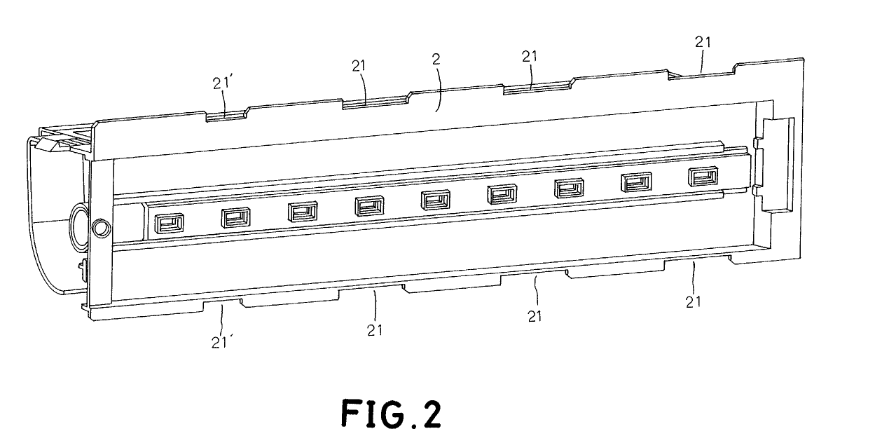

Referring to FIG. 2, the toner container 2 comprises toner stirring means and toner supplying openings (the toner stirring means and toner supplying openings are not within the scope of the claims of the present invention, no further detailed description is necessary). The toner container 2 further comprises at least one, for example, a plurality of first female engagement portions 21, and at least one, for example, a plurality of second female engagement portions 21′. The first female engagement portions 21 and the second female engagement portions 21′ have different longitudinal lengths.

Referring to FIG. 1 again, the developing device 1 comprises a plurality of first male engagement portions 11 and a plurality of second male engagement portions 11′ respectively disposed corresponding to the first female engagement portions 21 and the second female engagement portions 21′ of the toner container 2. The first male engagement portions 11 and the second male engagement portions 11′ have different sizes, and are adapted for engaging the first female engagement portions 21 and the second female engagement portions 21′ of the toner container 2 respectively.

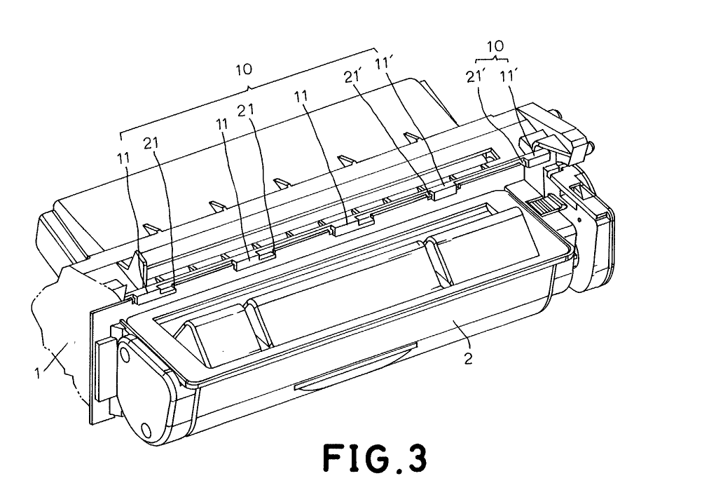

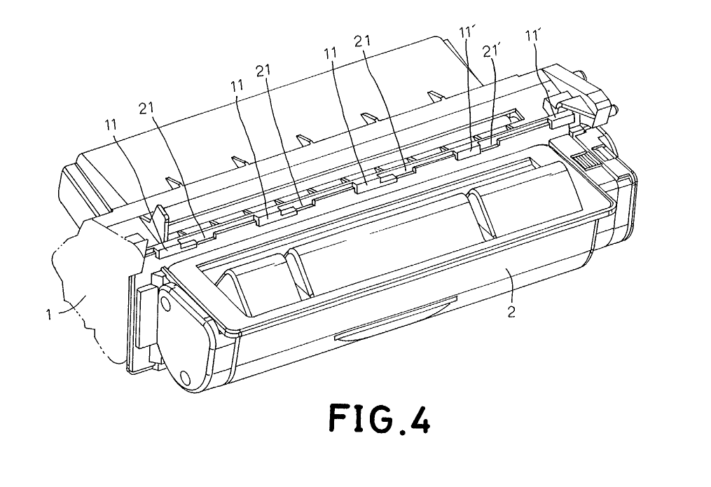

Referring to FIGS. 3 and 4 and FIG. 1 again, during installation, the toner container 2 is attached to the developing device 1, keeping the first female engagement portions 21 and second female engagement portions 21′ of the toner container 2 respectively positioned in the first male engagement portions 11 and second male engagement portions 11′ of the developing device 1, i.e., the initial engagement position 10 as shown in FIG. 3, and then the developing device 1 and the toner container 2 are moved relative to each other subject to the designed direction to force the first male engagement portions 11 and second male engagement portions 11′ of the developing device 1 into engagement with the first female engagement portions 21 and second female engagement portions 21′ of the toner container 2 respectively. Because the first male engagement portions 11 and the second male engagement portions 11′ have different sizes and the first female engagement portions 21 and the second female engagement portion 21′ fit the first male engagement portions 11 and the second male engagement portions 11′ respectively, the toner container 2 cannot be closely attached to the developing device and secured thereto in the correct position if the first female engagement portions 21 and the second female engagement portion 21′ are not aimed at the first male engagement portions 11 and the second male engagement portions 11′ respectively. The first male engagement portions 11 and second male engagement portions 11′ of the developing device 1 and the first female engagement portions 21 and second female engagement portions 21′ of the toner container 2 form a foolproof device, which prevents leakage of toner due to an installation error of the toner container 2 in the developing device 1.

A prototype of foolproof device has been constructed with the features of FIGS. 1˜4. The foolproof device functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A foolproof device used in an image forming apparatus comprising a developing device adapted for receiving toner and forming images with received toner and a toner container adapted for supplying toner to said developing device for forming images, the foolproof device comprising a plurality of first engagement portions formed in one of said developing device and said toner container, and a plurality of second engagement portions formed in the other of said developing device and said toner container and adapted for engaging said first engagement portions respectively, said first engagement portions having different longitudinal lengths, said second engagement portions having different sizes respectively fitting lengths of said first engagement portions.
